(19) United States
(12) Patent Application Publication
(10) Pub. No.: US 2024/0220787 A1
(43) Pub. Date: Jul. 4, 2024

(54) NEUROMORPHIC COMPUTING SYSTEM FOR EDGE COMPUTING

(71) Applicant: GM Cruise Holdings LLC, San Francisco, CA (US)

(72) Inventor: Juan Nunez, Palo Alto, CA (US)

(21) Appl. No.: 18/092,694

(22) Filed: Jan. 3, 2023

(51) Int. Cl. G06N 3/065; G06N 3/049; G06N 3/08

(52) U.S. Cl. CPC G06N 3/065; G06N 3/049; G06N 3/08

(57) ABSTRACT

Systems and techniques are provided for neuromorphic computing at edge devices such as sensor systems. An example system can include a sensor configured to collect sensor data; a neuromorphic compute platform including processing circuitry collocated with memory circuitry and communication channels interconnecting the processing circuitry and the memory circuitry; and one or more neural networks implemented by the neuromorphic compute platform, wherein the one or more neural networks are configured to process the sensor data from the sensor.

### TECHNICAL FIELD

The present disclosure generally relates to neuromorphic computing. For example, aspects of the present disclosure relate to techniques and systems for neuromorphic computing for edge-based perception.

### BACKGROUND

Various types of sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. For example, image sensors are often integrated into a wide array of electronic devices. The image sensors allow users to capture frames (e.g., video frames and/or still pictures/images) from any electronic device equipped with an image sensor. The frames can be captured for recreational use, automation, professional photography, surveillance, modeling, and depth estimation, among other applications. As another example, autonomous vehicles are typically equipped with various sensors, such as camera sensors, light detection and ranging (LIDAR) sensors, inertial measurement units (IMUs), and radio detection and ranging (RADAR) sensors, amongst others. Autonomous vehicles are motorized vehicles that can navigate without a human driver. The sensors on an autonomous vehicle can collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, in accordance with some examples of the present disclosure;

FIG. 2 is a diagram illustrating an example configuration of a sensor system implementing neuromorphic computing, in accordance with some examples of the present disclosure;

FIG. 3 is a diagram illustrating another example configuration of a sensor system, in accordance with some examples of the present disclosure;

FIG. 4 illustrates an example configuration of a neural network that can be implemented by a neuromorphic compute platform, in accordance with some examples of the present disclosure;

FIG. 5 is a diagram illustrating an example architecture of a neuromorphic compute platform, in accordance with some examples of the present disclosure;

FIG. 6 is a flowchart illustrating an example process for implementing neuromorphic computing at one or more edge devices, in accordance with some examples of the present disclosure;

FIG. 7 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of the subject matter of the application. However, it will be apparent that various aspects and examples of the disclosure may be practiced without these specific details. The figures and description are not intended to be restrictive.

The ensuing description provides examples and aspects of the disclosure, and is not intended to limit the scope, applicability, or configuration of the disclosure. Rather, the ensuing description of the examples and aspects of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, various types of sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. For example, an autonomous vehicle (AV) can include various sensors, such as a camera sensor, a light detection and ranging (LIDAR) sensor, an inertial measurement unit (IMU), a radio detection and ranging (RADAR) sensor, amongst others, which the AV can use to collect data and measurements that the AV can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

In some examples, an AV may implement a lot of different sensors to collect different types of sensor data for a scene, which the AV can use to better understand the scene. However, in many cases, the high number of sensors implemented by an AV can significantly increase the energy requirements of the AV (e.g., based on the energy requirements of the various sensors), can increase the amount of heat generated by electrical components of the AV, increase the difficulty in performing thermal management for the various electrical components of the AV, and/or potentially increase the amount of space taken up by the various electrical components of the AV.

In some aspects, systems, apparatuses, processes (also referred to as methods), and computer-readable media (collectively referred to as “systems and techniques”) are described herein for implementing neuromorphic computing at edge devices of an AV, such as sensor devices. For example, the systems and techniques described herein can be used to implement neuromorphic computing for edge-based (e.g., sensor based) operations such as, for example and without limitation, edge-based perception. The systems and techniques described herein for implementing neuromorphic computing at edge devices (and any other devices) can reduce the overall amount of energy used and/or needed by the edge devices (e.g., sensors) implemented by the AV and/or the overall computing system of the AV, can reduce the overall heat generated by the edge devices of the AV (and consequently the overall heat generated by the computer system of the AV, including the edge devices of the AV), can reduce the overall size of and space taken up by the edge devices of the AV, reduce a complexity and/or difficulty of performing thermal management for the various edge devices of the AV (e.g., as well as the thermal management of the overall compute devices of the AV), and/or increase the speed and/or performance of the edge devices of the AV and any other devices implementing the systems and techniques described herein.

In some examples, neuromorphic computing can use very-large-scale integration (VLSI) systems that include electronic circuits that mimic neuro-biological architectures in the human nervous system. Moreover, neuromorphic computing can include analog, digital, or mixed-mode analog/digital VLSI, and software systems that implement models of neural systems for perception, motor control, multisensory integration, and/or any other operations and/or combinations thereof. While traditional neural network and machine learning computation are well suited for existing algorithms, and can provide either fast/faster computation or low/lower power consumption, but typically achieving one at the expense of the other (e.g., achieving fast/faster computation at the expense of power consumption, or low/lower power consumption at the expense of computation speed). On the other hand, neuromorphic computing systems, as further described herein, can achieve both fast/faster computation and low/lower power consumption. Thus, an edge device, such as a sensor, that implements neuromorphic computing according to the systems and techniques described herein can achieve faster computing (e.g., than a sensor that does not implement the neuromorphic computing described herein) and lower power consumption (e.g., than a sensor that does not implement the neuromorphic computing described herein).

A device, such as a sensor, implementing neuromorphic computing as described herein can implement a device architecture that collocates the compute components of the device, such as memory (and/or memory circuitry), processor(s) (and/or compute circuitry), and/or communication channels of the device. For example, an architecture of a sensor system implementing neuromorphic computing as described herein can collocate two or more compute components of the sensor system such as the sensor of the sensor system, a processor(s) of the sensor system, and a memory (or memories) of the sensor system. Non-limiting examples of sensor systems that can implement the systems and techniques described herein (e.g., including the neuromorphic computing) can include a camera sensor system, a light detection and ranging (LIDAR) sensor system, a radio detection and ranging (RADAR) sensor system, an ultrasonic sensor system, a depth sensor system or time-of-flight (TOF) sensor system, an inertial sensor system (e.g., an inertial measurement unit (IMU)), and/or any other sensor system. Non-limiting examples of processing devices implemented by sensor systems can include a central processing unit (CPU), a graphics processing unit (GPU), a digital signal processor (DSP), an image signal processor (ISP), an application-specific integrated circuit (ASIC), a computer vision (CV) processor, a neural network processor (NNP), a field-programmable gate array (FPGA), a compute circuit, and/or any other processing device.

The collocation of components of the system implementing the neuromorphic computing described herein can reduce the amount of heat generated by the system, reduce the power consumption (and needs) of the system, reduce the overall size of the system, reduce the complexity and/or difficulty of providing thermal management for the system, and/or increase the processing speed and/or performance of the system. In one illustrative example, an architecture of a sensor system (e.g., a camera sensor system, a LIDAR sensor system, a RADAR sensor system, an ultrasonic sensor system, a depth sensor system or TOF sensor system, an IMU, and/or any other sensor system) implementing neuromorphic computing as described herein can collocate a sensor of the sensor system (e.g., the image sensor, the LIDAR sensor, the RADAR sensor, the ultrasonic sensor, the depth or TOF sensor, the IMU sensor, etc.), a processor(s) of the sensor system (e.g., a CPU(s), a GPU(s), a DSP(s), an ISP(s), an ASIC(s), a CV processor(s), an NNP(s), an FPGA(s), and/or any other processing device(s) and/or circuitry), and memory (e.g., volatile memory, a memristor(s), a crossbar array implemented by a memory device, etc.) of the sensor system.

The architecture can collocate the sensor, compute, memory, and communication channel(s) interconnecting the compute and memory within a same circuit or chip, rather than implementing such components in different circuits/chips and communicatively coupling the components via one or more communication systems such as one or more buses or data buses, for example. A conventional computer chip architecture typically has a separate memory unit, a separate CPU, and separate data paths. With such architecture, information generally needs to be transmitted back and forth repeatedly between the different components of a computer as the computer completes a given task. This creates a bottleneck for time, energy, and bandwidth. On the other hand, by collocating resources (e.g., memory, compute, communication channels, sensor, etc.), a neuromorphic computing system can process information faster and more efficiently. The neuromorphic computing system can simultaneously be powerful and efficient.

The systems (e.g., edge devices) implementing the neuromorphic computing techniques described herein can perform parallel computing (e.g., the systems can handle multiple tasks at once), can achieve lower power consumption, can be increasingly flexible (e.g., can be high in adaptability and plasticity), are generalizable, have higher (e.g., than traditional systems) redundancy and/or fault tolerance (e.g., can continue to function as expected even after a component has failed), have higher (e.g., than traditional systems) energy efficiency (e.g., parts and/or components of the system in use require power while other parts and/or components of the system which are not in use may not require power), and/or can be event-driven (e.g., can responds to events based on variable conditions). The neuromorphic computing system (e.g., a device, such as a sensor, implementing neuromorphic computing as described herein) can achieve brain-like functions and efficiency, and can build artificial neural systems that implement “neurons” (e.g., the nodes that process information) and “synapses” (e.g., memory) to transfer electrical signals using circuitry. The “neurons”, “synapses”, and electrical signals can allow the neuromorphic computing systems to modulate the amount of electricity flowing between nodes to mimic one or more aspects of the human brain.

In some cases, the neuromorphic computing system can implement an event-driven neural network (NN) such as, for example and without limitation, a spiking neural network (SNN). An example SNN can include the “neurons” and “synapses” that transmit electric pulses (e.g., the electrical signals transferred using circuitry and/or used to modulate the amount of electricity flowing between nodes of the SNN). In some examples, the SNN can measure discrete electrical signal changes as opposed to conventional neural networks that use less nuanced signals. In some implementations, an example SNN can simulate natural learning (e.g., by dynamically re-mapping the neural network) and can be used by the neuromorphic computing system to make decisions in response to learned patterns over time. Moreover, the neuromorphic computing system can collocate resources on each individual neuron and synapse, instead of having separate areas designated for resources. By collocating resources, the neuromorphic computing system can process information more efficiently. In some examples, each neuron of the neuromorphic computing system can perform either processing or memory, depending on the given task.

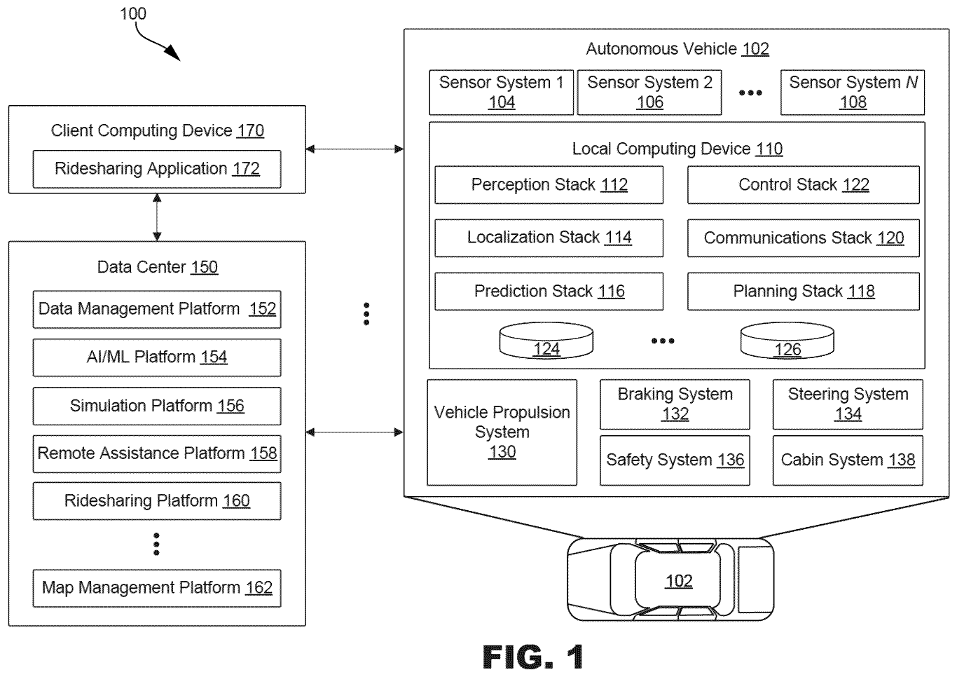

Various examples of the systems and techniques described herein for processing data are illustrated in FIG. 1 through FIG. 7 and described below.

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. In some cases, the client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit to a pick-up or drop-off location, and so on.

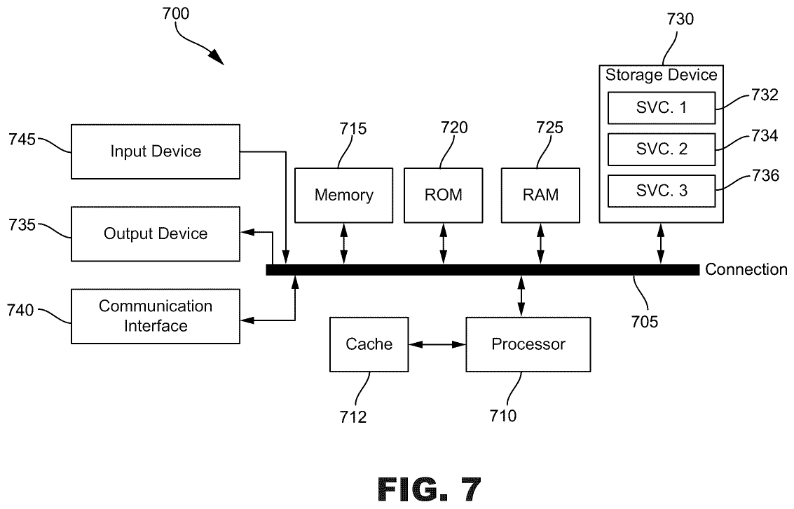

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

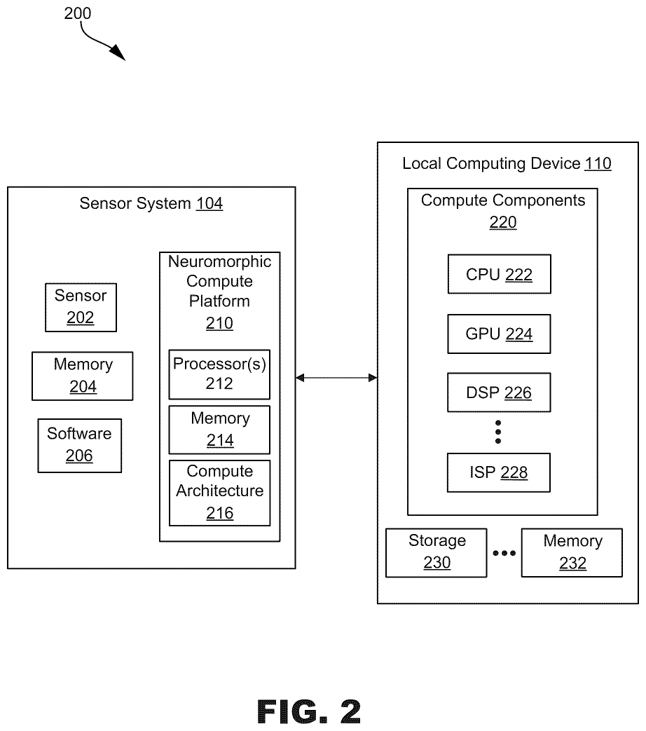

FIG. 2 is a diagram illustrating an example configuration 200 of a sensor system 104 implementing neuromorphic computing, according to some examples of the present disclosure. The sensor system 104 can include a sensor 202 used to capture sensor data, such as a LIDAR sensor, an image sensor, a RADAR sensor, an IMU sensor, a TOF sensor, an ultrasonic sensor, and/or any other sensor. The sensor system 104 can also include memory to store data and software such as, for example, and without limitation, firmware, an operating system (OS) of the sensor system 104, one or more software algorithms, modules, and/or services of the sensor system 104 and/or any other type of software.

The sensor system 104 can also implement a neuromorphic compute platform 210. The neuromorphic compute platform 210 can include a processor(s) 212 (or multiple processors), memory 214, and a compute architecture 216. The processor(s) 212 can include, for example and without limitation, a CPU, a GPU, a DSP, an ISP, an ASIC, an FPGA, an NNP, a CV processor, and/or any other type of processor. In one illustrative example, the processor(s) 212 can include one or more GPUs. In other examples, the processor(s) 212 can include any other type of processor such as, for example, a CPU. The neuromorphic compute platform 210 can collocate the processor(s) 212 and the memory 214 for parallel processing, energy efficiency, smaller form factor, processing efficiency, improved thermal management, etc.

In an illustrative example, the sensor 202 can include a LIDAR sensor and/or an image sensor. For example, the sensor 202 can include an image sensor configured to capture image data and generate frames based on the captured image data and/or provide the image data or frames to the neuromorphic compute platform 210 (and/or the local computing device 110) for processing. A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture.

In some examples, the compute architecture 216 can include an embedded computing board and/or parallel computing platform. The compute architecture 216 can include a software layer that provides direct access to the processor's virtual instruction set and parallel computational elements, which can enable execution of compute kernels and/or other instructions and/or compute. In some cases, the compute architecture 216 can include an application programming interface (API) that allows software to use the processor(s) 212 in certain ways. For example, if the processor(s) 212 is a GPU, the compute architecture 216 can include an API that allows software to use the GPU for general purpose processing, also referred to as general-purpose computing on GPUs (GPGPU).

In some examples, the compute architecture 216 can enable the neuromorphic compute platform 210 to perform scattered reads (e.g., reads from arbitrary addresses in memory), shared memory, faster downloads and readbacks to and from the processor(s) 212, unified virtual memory, unified memory, support for integer and bitwise operations, among other things. The compute architecture 216 can communicate with the sensor 202, the memory 204, and the software 206. Moreover, in some cases, the sensor system 104 can be communicatively coupled to the local computing device 110 of the AV (e.g., AV 102). In some cases, the local computing device 110 can represent an autonomous driving system computer (ADSC) of the AV.

In some aspects, the local computing device 110 can be configured to provide one or more functionalities such as, for example, imaging functionalities, three-dimensional (3D) image filtering functionalities, segmentation functionalities, mapping functionalities, tracking functionalities, localization functionalities, depth estimation functionalities, sensor data processing functionalities, phase unwrapping functionalities, high dynamic range (HDR) processing functionalities, AV perception functionalities, planning functionalities, navigation functionalities, detection functionalities (e.g., object detection, pose detection, face detection, shape detection, scene detection, etc.), image processing functionalities, classification functionalities, content rendering, device management, control functionalities, autonomous driving functionalities, computer vision, robotic functions, automation, and/or any other computing functionalities.

As shown in FIG. 2, the local computing device 110 can include compute components 220, storage 230, and memory 232. In some cases, the local computing device 110 can optionally include one or more other/additional devices/components such as, for example and without limitation, a light-emitting diode (LED) device, a cache, a communications interface, an output device such as a display, a sensor(s), an antenna, an input device, etc. An example architecture and example hardware components that can be implemented by the local computing device 110 are further described below with respect to FIG. 7.

The local computing device 110 can be part of, or implemented by, a single computing device or multiple computing devices. In some examples, the local computing device 110 can be part of and/or include an electronic device (or devices) such as a computer system (e.g., a server, a laptop computer, a tablet computer, etc.), a camera system (e.g., a digital camera, an IP camera, a video camera, a security camera, etc.), a telephone system (e.g., a smartphone, a cellular telephone, a conferencing system, etc.), a display device, an XR device such as a head-mounted display (TIMD), an IoT (Internet-of-Things) device, or any other suitable electronic device(s). In some implementations, the compute components 220, the storage 230, and/or the memory 232 can be part of the same computing device. For example, in some cases, the compute components 220, the storage 230, and/or the memory 232 can be integrated with or into a server computer, an ADSC of an AV, and/or any other computing device. In other implementations, the compute components 220, the storage 230, and/or the memory 232 can be part of, or implemented by, two or more separate computing devices.

The one or more compute components 220 of the local computing device 110 can include, for example and without limitation, a central processing unit (CPU) 222, a graphics processing unit (GPU) 224, a digital signal processor (DSP) 226, and/or an image signal processor (ISP) 228. In some examples, the local computing device 110 can include other processors or processing devices such as, for example, a CV processor, an NNP, an ASIC, an FPGA, etc. The local computing device 110 can use the one or more compute components 220 to perform various computing operations such as, for example, image processing functionalities, autonomous driving operations, mapping operations, tracking operations, localization operations, extended reality operations, detection operations (e.g., face detection, object detection, scene detection, human detection, etc.), image segmentation operations, device control operations, image/video processing operations, graphics rendering, machine learning and/or artificial intelligence, data processing, modeling, calculations, computer vision, and/or any other operations.

In some cases, the one or more compute components 220 can include other electronic circuits or hardware, computer software, firmware, or any combination thereof, to perform any of the various operations described herein. In some examples, the one or more compute components 220 can include more or less compute components than those shown in FIG. 2. Moreover, the CPU 222, the GPU 224, the DSP 226, and the ISP 228 are merely illustrative examples of compute components provided for explanation purposes.

The storage 208 can include any storage device(s) for storing data such as, for example and without limitation, sensor data (e.g., image data, LIDAR data, RADAR data, TOF data, inertial measurements, acoustic data, etc.), calculations, outputs, inputs, posture data, scene data, user data, preferences, vehicle data, software, etc. The storage 208 can store data from any of the components of the local computing device 110. For example, the storage 208 can store data and/or measurements from any of the compute components 220 (e.g., processing parameters, outputs, video, images, segmentation maps/masks, depth maps, filtering results, confidence maps, masks, calculation results, detection results, automation data, outputs, inputs, etc.) and/or any other components. In some examples, the storage 208 can include a buffer for storing data for processing by the compute components 220. The local computing device 110 can also include memory 232 to store any data processed (e.g., inputs, outputs, processed data, etc.) by the local computing device 110. In some examples, the memory 232 can include read-only memory (ROM), random-access memory (RAM), cache, and/or the like.

The one or more compute components 220 can perform image/video processing, HDR functionalities, machine learning, depth estimation, XR processing, device management/control, detection (e.g., object detection, face detection, scene detection, human detection, etc.), mapping, tracking, localization, navigation, perception, planning, and/or other operations as described herein. In some examples, the one or more compute components 220 can implement one or more software engines and/or algorithms such as, for example, a data processing engine or algorithm, a neural network, etc. In some cases, the one or more compute components 220 can implement one or more other or additional components and/or algorithms such as a machine learning model(s), a computer vision algorithm(s), a neural network(s), and/or any other algorithm and/or component.

The components shown in FIG. 2 with respect to the sensor system 104 and the local computing device 110 are illustrative examples provided for explanation purposes. In other examples, the sensor system 104 and/or the local computing device 110 can include more or less components than those shown in FIG. 2. While the sensor system 104 and the local computing device 110 is shown to include certain components, one of ordinary skill will appreciate that the sensor system 104 and/or the local computing device 110 can include more or fewer components than those shown in FIG. 2. For example, the sensor system 104 and/or the local computing device 110 can include, in some instances, one or more memory devices (e.g., RAM, ROM, cache, and/or the like), one or more networking interfaces (e.g., wired and/or wireless communications interfaces and the like), one or more display devices, caches, and/or other hardware or processing devices that are not shown in FIG. 2. An illustrative example of a computing device and/or hardware components that can be implemented with the sensor system 104 and/or the local computing device 110 are described below with respect to FIG. 7.

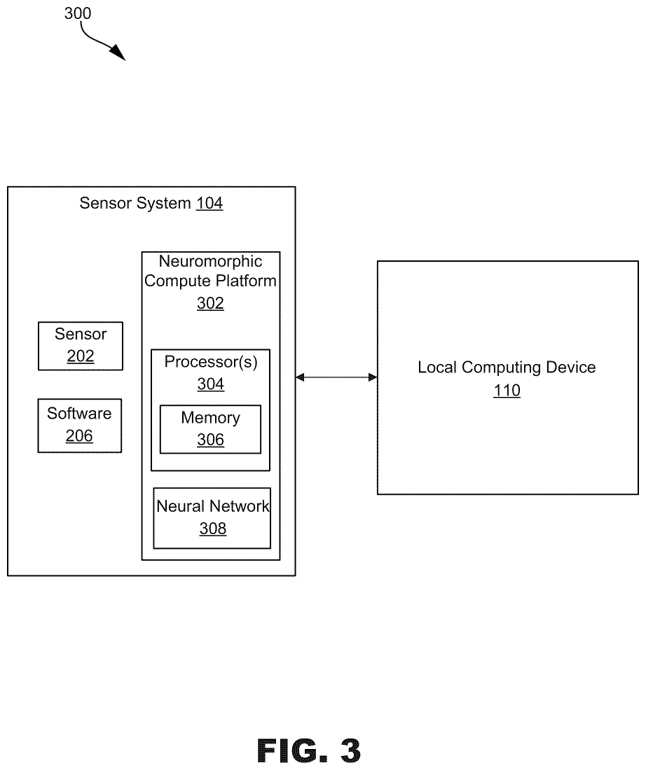

FIG. 3 is a diagram illustrating another example configuration 300 of the sensor system 104. The example configuration 300 illustrates an example neuromorphic computing implementation on an edge device (e.g., the sensor system 104), according to some examples of the present disclosure. In the example configuration 200 shown in FIG. 2, the sensor system 104 shown in FIG. 3 includes the sensor 202, software 206, and a neuromorphic compute platform 302. The neuromorphic compute platform 302 in this example includes a processor(s) 304, memory 306, and a neural network 308 configured to perform one or more tasks. In the neuromorphic compute platform 302 shown in FIG. 3, the processor(s) 304 and the memory 306 are collocated.

Thus, the sensor system 104 in FIG. 3 not only includes the sensor 202 used to collect sensor data, but also the compute (e.g., the processor(s) 304 and the memory 306) used to process the sensor data. The sensor system 104 is therefore able to process the data from the sensor 202 and performed one or more operations/functions with that data at the sensor system 104 itself, rather than having to offload such processing to the local computing device 110 or to a separate processor and memory. Moreover, by collocating the processor(s) 304 and the memory 306, the configuration 300 of the sensor system 104 can increase the processing efficiency of the sensor system 104 (e.g., the neuromorphic compute platform 302 can efficiently process information without needing to make direct memory access calls), decrease the power consumption of the sensor system 104, and increase parallel computing.

As previously mentioned, the neural network 308 of the neuromorphic compute platform 302 can be configured to process data from the sensor 202. For example, the neural network 308 can be configured to use the data from the sensor 202 to perform perception operations, such as detection, tracking, and planning. In other examples, the neural network 308 can additionally or alternatively be configured to use the data from the sensor 202 to perform any other operations, such as pre-processing operations, filtering operations, learning operations, recognition operations (e.g., object recognition, scene recognition, facial recognition, pattern recognition, etc.), segmentation, one or more other AV operations, and/or any other operations that use data from the sensor 202.

In some examples, the sensor 202 can include a LIDAR sensor. In other examples, the sensor 202 can include any other type of sensor such as, for example and without limitation, a camera sensor, a RADAR sensor, an IMU sensor, an ultrasonic sensor, and/or any other sensor. Moreover, in some examples, the processor(s) 304 can include one or more GPUs, CPUs, ISPs, DSPs, FPGAs, ASICs, NNPs, CV processors, processing circuits, and/or any other processors and/or processing circuitry. The memory 306 can include volatile memory, such as RAM memory, one or more memristors, one or more memory circuits, and/or any other type of memory and/or memory circuitry such as cache and/or non-transitory computer-readable media. In some cases, the neuromorphic compute platform 302 can represent a neurosynaptic core (e.g., neurosynaptic processing unit) with collocated processing and memory (e.g., processor(s) 304 and memory 306).

For example, the neuromorphic compute platform 302 can include a neurosynaptic core that integrates computation (e.g., neurons), communication, and memory (e.g., synapses), which allows efficient processing, efficient communication between computation and memory components, lower power (e.g., relative to traditional computing architectures), and/or increased parallelization. In some cases, the neurosynaptic core can include compute/processing circuitry (e.g., neurons) and memory (e.g., synapses) implemented with volatile memory circuitry such as a RAM, static RAM (SRAM), dynamic RAM (DRAM), or SDRAM crossbar array.

The neuromorphic compute platform 302 can implement any type of neural network(s) (e.g., neural network 308). In some examples, the neuromorphic compute platform 302 can be tuned for a particular type of neural network(s). For example, in some cases, the neuromorphic compute platform 302 can be tuned for spiking neural networks. In such cases, the neural network 308 can include a spiking neural network (SNN). In other cases, the neuromorphic compute platform 302 can be tuned for any other type of neural network.

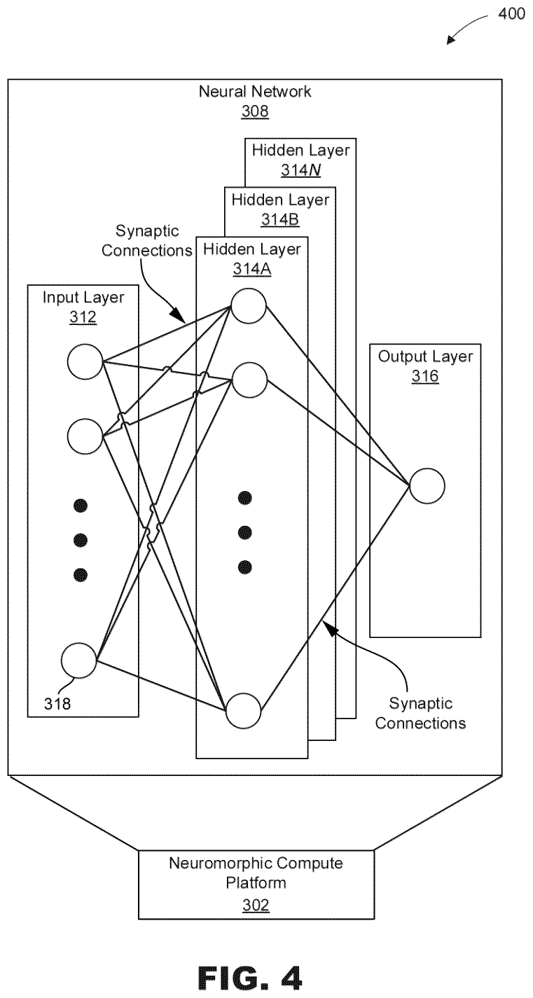

The neural network 308 can include nodes or neurons configured to perform certain tasks/functions, as further described below with respect to FIG. 4. The nodes or neurons can use the processor(s) 304 and memory 306 to perform their given tasks/functions. Moreover, because the processor(s) 304 and memory 306 are collocated, each node or neuron of the neural network 308, which is implemented by the neuromorphic compute platform 302 (e.g., by the processor(s) 304 and memory 306), can perform processing and/or memory operations, depending on the given task of that node or neuron, without transferring through a communication system such as a bus between the processor(s) 304 and memory 306. For example, depending on a given task, a node or neuron of the neural network 308 can perform in-memory processing and/or data storage operations by leveraging the collocated compute (e.g., processor(s) 304) and memory (e.g., memory 306) in the neuromorphic compute platform 302.

As previously explained, traditional computing architectures have separate memory, processors, and data paths. Thus, traditional computing architectures may experience delays and bottlenecks due to the need to transmit information between the memory, processors, and data paths. On the other hand, the neuromorphic compute platform 302 removes the bottleneck of information in traditional computing architectures and increases the processing efficiency (and parallelization) of the sensor system 104 as the memory and processor units are collocated. In addition, the sensor system 104 can process the data from the sensor 202 at the sensor system 104 itself rather than having to send the data from the sensor 202 to the local computing device 110 or to a separate processor and/or memory for processing.

In some examples, the neuromorphic compute platform 302 can be implemented by a neurosynaptic core circuit that includes the processor(s) 304, memory 306, and the neural network 308. In some cases, the neurosynaptic core circuit can represent a network of neurosynaptic cores. For example, the neuromorphic compute platform 302 can provide a network of low power (e.g., relative to traditional computing architectures) neurosynaptic cores (e.g., neurosynaptic processing units) represented by the processor(s) 304 and memory 306, configured to implement the neural network 308. In some examples, the neural network 308 can include an SNN, and the neurosynaptic cores can use spikes to encode information. The neurons on each neurosynaptic core can connect to any axon of any other neurosynaptic core or any axon on a same neurosynaptic core. When a neuron spikes, the neuron can send associated information to a particular axon on a neurosynaptic core.

In some examples where the neural network 308 is an SNN, the neural network 308 can transmit or transfer packets of information over a switched communication system or line, which can increase the efficiency of the neuromorphic compute platform 302 and reduce its overall size. The neural network 308 can flip a bit to 1 when it determines that there is a spike (and/or can treat the spike as receipt of a bit with a value of 1), and 0 when there are no spikes (and/or can treat the lack of a spike as receipt of a bit with a value of 0). A spike communication from a neuron on a neurosynaptic core to an axon on a target neurosynaptic core can travel one or more hops in a grid for delivery to the axon on the target neurosynaptic core.

In some cases, the neuromorphic compute platform 302 can allow a window of time (e.g., referenced herein as a tick) for a spike to travel to a target axon from the sending neuron. In some examples, at each tick, the neurons in a neurosynaptic core can be processed sequentially. For example, at each tick, the neuromorphic compute platform 302 can start with the first neuron and continue processing neurons sequentially until it reaches the last neuron.

FIG. 4 illustrates an example configuration 400 of a neural network 308 that can be implemented by a neuromorphic compute platform, such as the neuromorphic compute platform 302 shown in FIG. 3. The example configuration 400 is merely one illustrative example provided for clarity and explanation purposes. One of ordinary skill in the art will recognize that other configurations of a neural network are also possible and contemplated herein.

In this example, the neural network 308 includes an input layer 312 which includes input data. The input data can include sensor data such as, for example, image data (e.g., video frames, still images, etc.) from one or more image sensors, LIDAR data from one or more LIDARs, and/or any other type of sensor data. For example, the input data can include data from the sensor 202 previously described with respect to FIGS. 2 and 3. The input data can capture, measure, and/or depict a view, scene, environment, shape, condition, scene element, and/or object. For example, the input data can depict a scene associated with an AV, such as the AV 102 shown in FIG. 1. In one illustrative example, the input layer 312 can include data representing the pixels of one or more input images depicting an environment of the AV 102. In other examples, the input layer 312 can include other sensor data such as, for example, LIDAR data, ultrasonic sensor data, IMU data, RADAR data, and/or any other type of sensor data.

The neural network 308 includes hidden layers 314A through 314N (collectively “314” hereinafter). The hidden layers 314 can include n number of hidden layers, where n is an integer greater than or equal to one. The number of hidden layers can be made to include as many layers as needed for a given application. The neural network 308 further includes an output layer 316 that provides an output resulting from the processing performed by the hidden layers 314. In one illustrative example, the output layer 316 can provide a classification and/or localization of one or more objects in an input, such as an input of sensor data. The classification can include a class identifying the type of object or scene (e.g., a car, a pedestrian, an animal, a train, an object, or any other object or scene). In some cases, a localization can include a bounding box indicating the location of an object or scene.

The neural network 308 can include a multi-layer deep learning network of interconnected nodes. Each node can represent a piece of information. Information associated with the nodes is shared among the different layers. In some examples, each layer can retain information as information is processed. In some cases, the neural network 308 can include a feedforward network, in which case there are no feedback connections where outputs of the network are fed back into itself. For example, the neural network 308 can implement a backpropagation algorithm for training the feedforward neural network. In some cases, the neural network 308 can include a recurrent neural network, which can have loops that allow information to be carried across nodes while reading in input.

Information can be exchanged between nodes through node-to-node interconnections between the various layers. In some cases, the nodes can be implemented by a processing device or circuit, such as processor(s) 304, and the node-to-node interconnections can represent synapses implemented by a crossbar array formed by a memory device or circuit (e.g., memory 306) such as a volatile memory. Nodes of the input layer 312 can activate a set of nodes in the first hidden layer 314A. For example, as shown, each of the input nodes of the input layer 312 is connected to each of the nodes of the first hidden layer 314A. The nodes of the hidden layer 314A can transform the information of each input node by applying activation functions to the information. The information derived from the transformation can be passed to and can activate the nodes of the next hidden layer (e.g., 314B), which can perform their own designated functions. Example functions include convolutional, up-sampling, data transformation, pooling, and/or any other suitable functions. The output of the hidden layer (e.g., 314B) can activate nodes of the next hidden layer (e.g., 314N), and so on. The output of the last hidden layer can activate one or more nodes of the output layer 316, at which point an output is provided. In some cases, while nodes (e.g., node 318) in the neural network 308 are shown as having multiple output lines, a node has a single output and all lines shown as being output from a node represent the same output value.

In some cases, each node or interconnection between nodes can have a weight that is a set of parameters derived from training the neural network 308. For example, an interconnection between nodes can represent a piece of information learned about the interconnected nodes. The interconnection can have a numeric weight that can be tuned (e.g., based on a training dataset), allowing the neural network 308 to be adaptive to inputs and able to learn as more data is processed.

The neural network 308 can be pre-trained to process features from the data in the input layer 312 using the different hidden layers 314 in order to provide the output through the output layer 316. In an example in which the neural network 308 is used to identify objects or features in images, the neural network 308 can be trained using training data that includes images and/or labels. For instance, training images can be input into the neural network 308, with each training image having a label indicating the classes of the one or more objects or features in each image (e.g., indicating to the network what the objects are and what features they have).

In some cases, the neural network 308 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 308 is trained enough so that the weights of the layers are accurately tuned.

For the example of identifying objects in images, the forward pass can include passing a training image through the neural network 308. The weights can be initially randomized before the neural network 308 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 308, the output can include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 308 is unable to determine low level features and thus cannot make an accurate determination of what the classification of the object might be. A loss function can be used to analyze errors in the output. Any suitable loss function definition can be used.

The loss (or error) can be high for the first training images since the actual values will be different than the predicted output. The goal of training is to minimize the amount of loss so that the predicted output is the same as the training label. The neural network 308 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 308 can include any suitable deep network. For example, the neural network 308 can include an artificial neural network, such as an SNN. An artificial neural network such as an SNN can mimic natural neural networks of the human brain. In some examples, an SNN can implement neuronal and synaptic states as well as the concept of time. For example, rather than transmitting information at each propagation cycle, the neurons in the SNN may transmit information when a membrane potential reaches a specific value or threshold. A membrane potential can refer to a quality of the neuron related to its membrane electrical charge. When the membrane potential reaches the threshold, the neuron can fire and generate a signal transmitted to other neurons which adjust (e.g., increase or decrease) their membrane potentials in response to the signal. The SNN can include a neuron model that fires at the moment of the threshold. The spiking neuron model can include, for example, a leaky integrate-and-fire model. With the integrate-and-fire model, the momentary activation level can be considered to be the neuron's state. Incoming spikes can increase or decrease such value until the state decays or the neuron fires (e.g., if the firing threshold is reached). After firing, the state variable can be reset to a lower value.

Another illustrative example of a neural network (e.g., neural network 308) can include a convolutional neural network (CNN). The CNN can include an input layer, one or more hidden layers, and an output layer, as previously described. The hidden layers of a CNN can include a series of convolutional, nonlinear, pooling (e.g., for down sampling), and fully connected layers. In other examples, the neural network 308 can represent any other deep network other than an artificial neural network or CNN, such as an autoencoder, a deep belief nets (DBNs), a Recurrent Neural Networks (RNNs), etc.

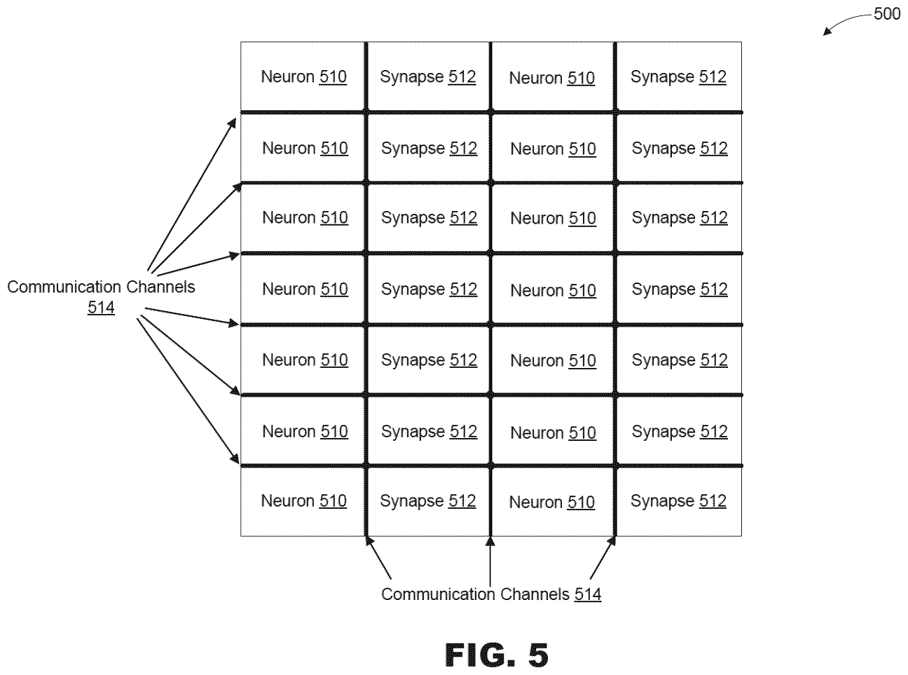

FIG. 5 is a diagram illustrating an example architecture 500 of a neuromorphic compute platform, such as neuromorphic compute platform 302, according to some examples of the present disclosure. In some cases, the neuromorphic compute platform can represent one or more neurosynaptic cores, and the architecture 500 can reflect an example architecture of the one or more neurosynaptic cores.

As shown, the architecture 500 can include neurons 510, synapses 512, and communication channels 514. The neurons 510 can represent compute, the synapses 512 can represent memory, and the communication channels 514 can represent data paths. For example, the neurons 510 can represent computing units, the synapses 512 can represent local memory units, and the communication channels 514 can connect various neurons 510 and synapses 512.

The neurons 510 can be implemented by one or more processing/compute circuits (e.g., processor(s) 304) such as, for example and without limitation, one or more GPUs, CPUs, ISPs, DSPs, FPGAs, ASICs, NNPs, CV processors, and/or any other processors and/or processing circuitry. The synapses 512 can include volatile memory (e.g., RAM, SRAM, DRAM, SDRAM, etc.), one or more memristors, one or more memory circuits, and/or any other type of memory and/or memory circuitry such as cache and/or non-transitory computer-readable media. In some cases, the neuromorphic compute platform 302 can represent a neurosynaptic core (e.g., neurosynaptic processing unit) with collocated processing and memory (e.g., processor(s) 304 and memory 306). For example, the neurons 510 can include compute/processing circuitry and the synapses 512 can include volatile memory circuitry such as a RAM, SRAM, DRAM, or SDRAM crossbar array.

The collocation of the neurons 510, synapses 512, and communication channels 514 can achieve more efficient (e.g., relative to traditional computing architectures) processing, more efficient communication between computation (e.g., neurons 510) and memory components (e.g., synapses 512), lower power (e.g., relative to traditional computing architectures), and/or increased parallelization. The information can flow between neurons 510 through the communication channels 514 and modulated by the synapses 512. Moreover, the neuromorphic compute platform implementing the architecture 500 can perform parallel, event-driven computations where each circuit (e.g., each neuron) processes information in parallel and without a clock. The neuromorphic compute platform implementing the architecture 500 can also consume power and/or emit heat when necessary, leading to lower power consumption and heat emission (e.g., and thus easier thermal management) than traditional computing architectures. The collocated compute, memory, and communication channels of the architecture 500 can also require less bandwidth than tradition computing architectures and can avoid or minimize the bottlenecks in traditional computing architectures caused by the separation of memory and processing units.

The number and/or arrangement of neurons 510, synapses 512, and communication channels 514 shown in FIG. 5 are merely illustrative examples provided for explanation purposes. Other example implementations can include more or less neurons 510, synapses 512, and/or communication channels 514 than shown in FIG. 5 and/or a different arrangement of neurons 510, synapses 512, and/or communication channels 514 than shown in FIG. 5.

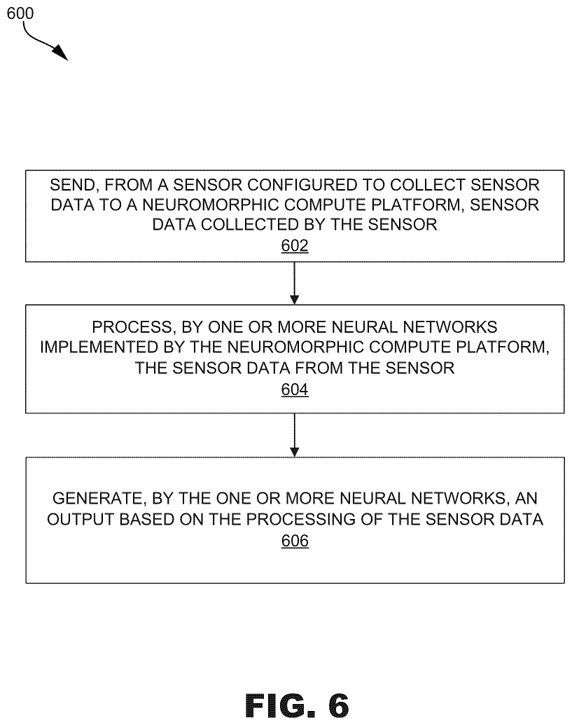

FIG. 6 is a flowchart illustrating an example process 600 for implementing neuromorphic computing at one or more edge devices. In some examples, the edge devices can include a sensor system such as, for example, a LIDAR, a camera system, a RADAR, an ultrasonic sensor system, an inertial measurement unit, and/or any other type of sensor system. In other examples, the edge devices can include an Internet-of-things (IoT) device such as, for example, a smart light, a smart appliance (e.g., a smart refrigerator, a smart oven, a smart thermostat, a smart dishwasher, a smart coffee maker, a smart vacuum cleaner, a smart switch, etc.), a smart television, a security camera, etc.

At block 602, the process 600 can include sending, from a sensor (e.g., sensor 202) configured to collect sensor data to a neuromorphic compute platform (e.g., neuromorphic compute platform 302), the sensor data collected by the sensor. In some examples, the neuromorphic compute platform can include processing circuitry collocated with memory circuitry and communication channels interconnecting the processing circuitry and the memory circuitry.

In some examples, the processing circuitry can include a GPU, a CPU, a DSP, an ISP, an FPGA, an NNP, and/or a compute circuit. Moreover, the memory circuitry can include, for example, a volatile memory (e.g., RAM, SRAM, DRAM, SDRAM, etc.), a memristor, and/or a crossbar array implemented by a volatile memory device and/or a memory circuit. The sensor can include, for example and without limitation, a LIDAR, a camera sensor, a RADAR, an ultrasonic sensor, an IMU, and/or any other type of sensor.

At block 604, the process 600 can include processing, by one or more neural networks (e.g., neural network 308) implemented by the neuromorphic compute platform, the sensor data from the sensor. In some examples, the neural network can include an artificial neural network, such as an SNN, for example. The artificial neural network can be configured to perform one or more operations, such as one or more sensor and/or AV operations. For example, the artificial neural network can be configured to perform perception sensing using the sensor data from the sensor. The perception sensing can include object detection, object tracking, depth or distance detection, localization, scene mapping, path planning, decision making, and/or one or more autonomous vehicle operations.

At block 606, the process 600 can include generating, by the one or more neural networks, an output based on the processing of the sensor data. For example, the one or more neural networks can generate a perception sensing output based on the sensor data. In some examples, the perception sensing output can include an object detection output, an object tracking output, a depth or distance detection output, a localization output, a scene mapping output, a path planning output, a decision-making output, and/or an autonomous vehicle operation output.

In some cases, the neuromorphic compute platform can include a plurality of neurons associated with the processing circuitry and a plurality of synapses associated with the memory circuitry. In some aspects, the process 600 can include receiving a spike event generated by a first neuron of the plurality of neurons; storing the spike event in a synapse of the plurality of synapses; sending the spike event to a second neuron of the plurality of neurons; and performing, by the second neuron, a spike computation. In some examples, the spike computation can include generating a second spike event. In other examples, the spike computation can include, for example, a filtering operation, an addition, a multiplication, a subtraction, a gradient computation, an inference, a classification operation, a training and/or learning operation, a backpropagation operation, a pattern and/or feature recognition operation, a feature extraction operation, a detection operation, a perception operation, and/or any other computation.

FIG. 7 illustrates an example processor-based system with which some aspects of the subject technology can be implemented. For example, processor-based system 700 can be any computing device making up local computing device 110, remote computing system 190, a passenger device executing the ridesharing application 170, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 can include an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, causes the system to perform a function. In some examples, a hardware service that performs a particular function can include the software component stored in a computer-readable medium in connection with the necessary hardware components, such as processor 710, connection 705, output device 735, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a sensor configured to collect sensor data; a neuromorphic compute platform comprising processing circuitry collocated with memory circuitry and communication channels interconnecting the processing circuitry and the memory circuitry; and one or more neural networks implemented by the neuromorphic compute platform, wherein the one or more neural networks are configured to process the sensor data from the sensor.

Aspect 2. The system of Aspect 1, wherein the processing circuitry comprises at least one of a graphics processing unit (GPU), a central processing unit (CPU), a digital signal processor (DSP), an image signal processor (ISP), a field-programmable gate array (FPGA), a neural network processor (NNP), and a compute circuit.

Aspect 3. The system of any of Aspects 1 or 2, wherein the memory circuitry comprises at least one of a volatile memory, a memristor, and a crossbar array implemented by at least one of a volatile memory device and a memory circuit.

Aspect 4. The system of any of Aspects 1 to 3, wherein the sensor comprises at least one of a light detection and ranging (LIDAR) sensor, a camera sensor, a radio detection and ranging (RADAR) sensor, and an ultrasonic sensor.

Aspect 5. The system of any of Aspects 1 to 4, wherein the neuromorphic compute platform comprises a plurality of neurons associated with the processing circuitry and a plurality of synapses associated with the memory circuitry.

Aspect 6. The system of Aspect 5, wherein the neuromorphic compute platform is configured to: receive a spike event generated by a first neuron of the plurality of neurons; store the spike event in a synapse of the plurality of synapses; send the spike event to a second neuron of the plurality of neurons; and perform, by the second neuron, a spike computation.

Aspect 7. The system of any of Aspects 1 to 6, wherein the neural network comprises an artificial neural network, and wherein the artificial neural network is configured to perform perception sensing using the sensor data from the sensor.

Aspect 8. The system of Aspect 7, wherein the perception sensing comprises at least one of object detection, object tracking, depth or distance detection, localization, scene mapping, path planning, decision making, and one or more autonomous vehicle operations.

Aspect 9. The system of any of Aspects 7 or 8, wherein the artificial neural network comprises a spiking neural network.

Aspect 10. The system of any of Aspects 1 to 9, wherein the system comprises a sensor system on an autonomous vehicle.

Aspect 11. A method comprising: sending, from a sensor configured to collect sensor data to a neuromorphic compute platform, the sensor data collected by the sensor, wherein the neuromorphic compute platform comprises processing circuitry collocated with memory circuitry and communication channels interconnecting the processing circuitry and the memory circuitry; processing, by one or more neural networks implemented by the neuromorphic compute platform, the sensor data from the sensor; and generating, by the one or more neural networks, an output based on the processing of the sensor data.

Aspect 12. The method of Aspect 11, wherein the processing circuitry comprises at least one of a graphics processing unit (GPU), a central processing unit (CPU), a digital signal processor (DSP), an image signal processor (ISP), a field-programmable gate array (FPGA), a neural network processor (NNP), and a compute circuit.

Aspect 13. The method of any of Aspects 11 or 12, wherein the memory circuitry comprises at least one of a volatile memory, a memristor, and a crossbar array implemented by at least one of a volatile memory device and a memory circuit.

Aspect 14. The method of any of Aspects 11 to 13, wherein the sensor comprises at least one of a light detection and ranging (LIDAR) sensor, a camera sensor, a radio detection and ranging (RADAR) sensor, and an ultrasonic sensor.

Aspect 15. The method of any of Aspects 11 to 14, wherein the neuromorphic compute platform comprises a plurality of neurons associated with the processing circuitry and a plurality of synapses associated with the memory circuitry.

Aspect 16. The method of Aspect 15, further comprising: receiving a spike event generated by a first neuron of the plurality of neurons; storing the spike event in a synapse of the plurality of synapses; sending the spike event to a second neuron of the plurality of neurons; and performing, by the second neuron, a spike computation.

Aspect 17. The method of any of Aspects 11 to 16, wherein the neural network comprises an artificial neural network, and wherein the artificial neural network is configured to perform perception sensing using the sensor data from the sensor.

Aspect 18. The method of Aspect 17, wherein the perception sensing comprises at least one of object detection, object tracking, depth or distance detection, localization, scene mapping, path planning, decision making, and one or more autonomous vehicle operations.

Aspect 19. The method of any of Aspects 17 or 18, wherein the artificial neural network comprises a spiking neural network.

Aspect 20. A non-transitory computer-readable medium having stored thereon instructions which, when executed by one or more processors, cause the one or more processors to perform a method according to any of Aspects 11 to 19.

Aspect 21. An autonomous vehicle comprising a computer device having stored thereon instructions which, when executed by the computing device, cause the computing device to perform a method according to any of Aspects 11 to 19.

Aspect 22. A computer-program product comprising instructions which, when executed by one or more processors, cause the one or more processors to perform a method according to any of Aspects 11 to 19.

Aspect 23. An autonomous vehicle comprising: a local computing device; and a sensor system communicatively coupled to the local computing device, the sensor system comprising: a sensor configured to collect sensor data; a neuromorphic compute platform comprising processing circuitry collocated with memory circuitry and communication channels interconnecting the processing circuitry and the memory circuitry; and one or more neural networks implemented by the neuromorphic compute platform, wherein the one or more neural networks are configured to process the sensor data from the sensor.

Aspect 24. The autonomous vehicle of Aspect 23, wherein the local computing device comprises instructions which, when executed by the local computing device, cause the local computing device to perform a method according to any of Aspects 11 to 19.

What is claimed is:

1. A system comprising:
a sensor configured to collect sensor data;
a neuromorphic compute platform comprising processing circuitry collocated with memory circuitry and communication channels interconnecting the processing circuitry and the memory circuitry; and
one or more neural networks implemented by the neuromorphic compute platform, wherein the one or more neural networks are configured to process the sensor data from the sensor.

2. The system of claim 1, wherein the processing circuitry comprises at least one of a graphics processing unit (GPU), a central processing unit (CPU), a digital signal processor (DSP), an image signal processor (ISP), a field-programmable gate array (FPGA), a neural network processor (NNP), and a compute circuit.

3. The system of claim 1, wherein the memory circuitry comprises at least one of a volatile memory, a memristor, and a crossbar array implemented by at least one of a volatile memory device and a memory circuit.

4. The system of claim 1, wherein the sensor comprises at least one of a light detection and ranging (LIDAR) sensor, a camera sensor, a radio detection and ranging (RADAR) sensor, and an ultrasonic sensor.

5. The system of claim 1, wherein the neuromorphic compute platform comprises a plurality of neurons associated with the processing circuitry and a plurality of synapses associated with the memory circuitry.

6. The system of claim 5, wherein the neuromorphic compute platform is configured to:
receive a spike event generated by a first neuron of the plurality of neurons;
store the spike event in a synapse of the plurality of synapses;
send the spike event to a second neuron of the plurality of neurons; and
perform, by the second neuron, a spike computation.

7. The system of claim 1, wherein the neural network comprises an artificial neural network, and wherein the artificial neural network is configured to perform perception sensing using the sensor data from the sensor.

8. The system of claim 7, wherein the perception sensing comprises at least one of object detection, object tracking, depth or distance detection, localization, scene mapping, path planning, decision making, and one or more autonomous vehicle operations.

9. The system of claim 7, wherein the artificial neural network comprises a spiking neural network.

10. The system of claim 1, wherein the system comprises a sensor system on an autonomous vehicle.

11. A method comprising:
sending, from a sensor configured to collect sensor data to a neuromorphic compute platform, the sensor data collected by the sensor, wherein the neuromorphic compute platform comprises processing circuitry collocated with memory circuitry and communication channels interconnecting the processing circuitry and the memory circuitry;
processing, by one or more neural networks implemented by the neuromorphic compute platform, the sensor data from the sensor; and
generating, by the one or more neural networks, an output based on the processing of the sensor data.

12. The method of claim 11, wherein the processing circuitry comprises at least one of a graphics processing unit (GPU), a central processing unit (CPU), a digital signal processor (DSP), an image signal processor (ISP), a field-programmable gate array (FPGA), a neural network processor (NNP), and a compute circuit.

13. The method of claim 11, wherein the memory circuitry comprises at least one of a volatile memory, a memristor, and a crossbar array implemented by at least one of a volatile memory device and a memory circuit.

14. The method of claim 11, wherein the sensor comprises at least one of a light detection and ranging (LIDAR) sensor, a camera sensor, a radio detection and ranging (RADAR) sensor, and an ultrasonic sensor.

15. The method of claim 11, wherein the neuromorphic compute platform comprises a plurality of neurons associated with the processing circuitry and a plurality of synapses associated with the memory circuitry.

16. The method of claim 15, further comprising:
receiving a spike event generated by a first neuron of the plurality of neurons;
storing the spike event in a synapse of the plurality of synapses;
sending the spike event to a second neuron of the plurality of neurons; and
performing, by the second neuron, a spike computation.

17. The method of claim 11, wherein the neural network comprises an artificial neural network, and wherein the artificial neural network is configured to perform perception sensing using the sensor data from the sensor.

18. The method of claim 17, wherein the perception sensing comprises at least one of object detection, object tracking, depth or distance detection, localization, scene mapping, path planning, decision making, and one or more autonomous vehicle operations.

19. The method of claim 17, wherein the artificial neural network comprises a spiking neural network.

20. An autonomous vehicle comprising:
a local computing device; and
a sensor system communicatively coupled to the local computing device, the sensor system comprising:
a sensor configured to collect sensor data;
a neuromorphic compute platform comprising processing circuitry collocated with memory circuitry and communication channels interconnecting the processing circuitry and the memory circuitry; and
one or more neural networks implemented by the neuromorphic compute platform, wherein the one or more neural networks are configured to process the sensor data from the sensor.
